(19) United States
(12) Patent Application Publication
(10) Pub. No.: US 2019/0094743 A1
(43) Pub. Date: Mar. 28, 2019

(54) CHARGING APPARATUS AND IMAGE FORMING APPARATUS

(71) Applicant: CANON KABUSHIKI KAISHA, Tokyo (JP)

(72) Inventor: Masanobu Nakajima, Toride-shi (JP)

(21) Appl. No.: 16/131,166

(22) Filed: Sep. 14, 2018

(30) Foreign Application Priority Data
Sep. 22, 2017 (JP) 2017-183031

(51) Int. Cl. G03G 15/02

(52) U.S. Cl. CPC G03G 15/0258

(57) ABSTRACT

A charging apparatus including: a first charging roller configured to charge a surface of a photosensitive drum by rotating in contact with the surface of the photosensitive drum; a second charging roller configured to charge the surface of the photosensitive drum by rotating in contact with the surface of the photosensitive drum at a position downstream of the first charging roller in a rotation direction of the photosensitive drum; and a cleaning roller configured to clean a surface of the first charging roller and a surface of the second charging roller by rotating along with rotation of the first and second charging rollers in contact with the surfaces of the first and second charging rollers, an inroad amount of the first charging roller into the cleaning roller being larger than an inroad amount of the second charging roller into the cleaning roller.

### BACKGROUND OF THE INVENTION

### Field of the Invention

The present invention relates to a charging apparatus configured to charge a surface of a photosensitive member, and an image forming apparatus including such charging apparatus, such as a copying machine, a printer, a facsimile machine, and a multifunction peripheral having a plurality of functions of those apparatus.

### Description of the Related Art

In Japanese Patent Application Laid-Open No. 2017-62440, there is proposed a charging apparatus having a configuration of charging a surface of a photosensitive member with two charging members and cleaning the two charging members with a single cleaning member.

In this case, the charging member on an upstream side in a rotation direction of the photosensitive member is liable to be unclean because toner or an external additive adhering to the photosensitive member is brought into contact with the charging member on the upstream side earlier than with the charging member on a downstream side.

### SUMMARY OF THE INVENTION

According to one embodiment of the present invention, there is provided a charging apparatus comprising:
a first charging roller configured to charge a surface of a photosensitive drum by rotating in contact with the surface of the photosensitive drum;
a second charging roller configured to charge the surface of the photosensitive drum by rotating in contact with the surface of the photosensitive drum at a position adjacent to and downstream of a position at which the first charging roller is in contact with the surface of the photosensitive drum with respect to a rotation direction of the photosensitive drum; and
a cleaning roller configured to clean a surface of the first charging roller and a surface of the second charging roller by rotating along with rotation of the first charging roller and the second charging roller in contact with the surface of the first charging roller and the surface of the second charging roller, an inroad amount of the first charging roller into the cleaning roller being larger than an inroad amount of the second charging roller into the cleaning roller.

According to another embodiment of the present invention, provided is an image forming apparatus comprising:
a photosensitive drum;
a first charging roller configured to charge a surface of the photosensitive drum by rotating in contact with the surface of the photosensitive drum;
a second charging roller configured to charge the surface of the photosensitive drum by rotating in contact with the surface of the photosensitive drum at a position adjacent to and downstream of a position at which the first charging roller is in contact with the surface of the photosensitive drum with respect to a rotation direction of the photosensitive drum;
a cleaning roller configured to clean a surface of the first charging roller and a surface of the second charging roller by rotating along with rotation of the first charging roller and the second charging roller in contact with the surface of the first charging roller and the surface of the second charging roller, an inroad amount of the first charging roller into the cleaning roller being larger than an inroad amount of the second charging roller into the cleaning roller;
an image forming portion configured to form an image on a recording material by forming a toner image on the charged photosensitive drum and transferring the toner image onto the recording material; and
an execution portion configured to execute a mode of applying a first direct-current voltage to the first charging roller so that the first charging roller charges the surface of the photosensitive drum and applying a second direct-current voltage, which is different from the first direct-current voltage, to the second charging roller.

Further features of the present invention will become apparent from the following description of exemplary embodiments with reference to the attached drawings.

### BRIEF DESCRIPTION OF THE DRAWINGS

FIG. 1 is a schematic configuration view of an image forming apparatus according to a first embodiment.

FIG. 2 is a control block diagram of the image forming apparatus according to the first embodiment.

FIG. 3A is a schematic view for illustrating configurations around a photosensitive drum in the first embodiment while omitting configurations other than a charging apparatus and a cleaning device.

FIG. 3B is a partially enlarged view of FIG. 3A.

FIG. 4 is an explanatory schematic view for illustrating a support structure for the charging apparatus according to the first embodiment.

FIG. 5 is an explanatory schematic view for illustrating circumferential speeds in the charging apparatus according to the first embodiment.

FIG. 6A is a graph for showing a voltage applied to a downstream charging roller in a discharge mode in the second embodiment.

FIG. 6B is a graph for showing a voltage applied to an upstream charging roller in the discharge mode in the second embodiment.

### DESCRIPTION OF THE EMBODIMENTS

### First Embodiment

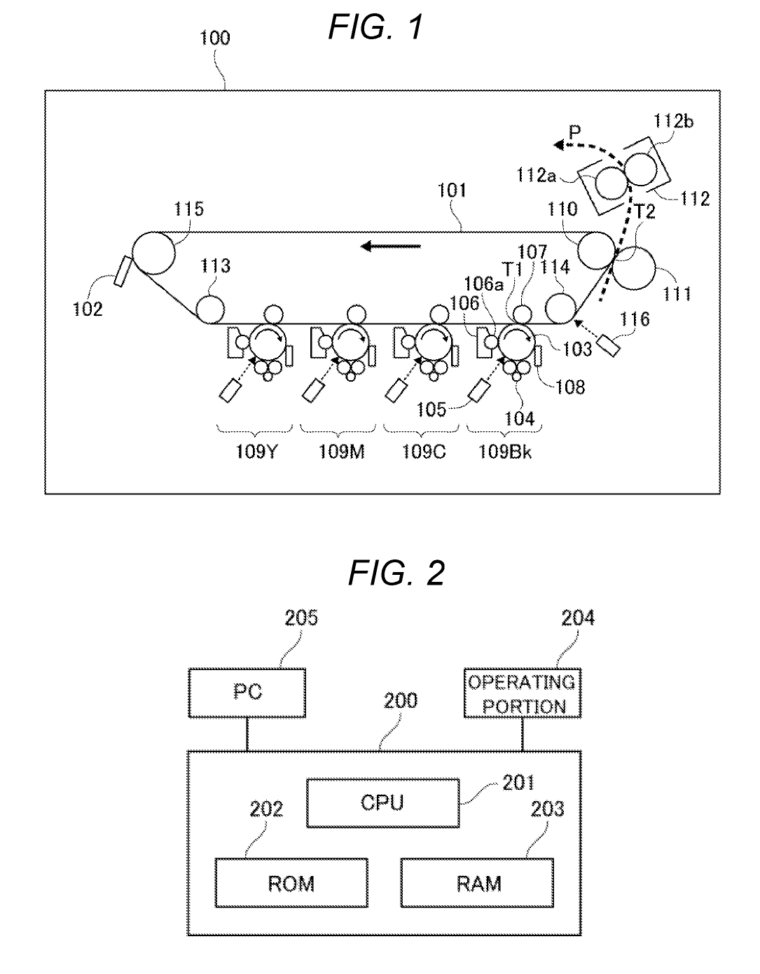

A first embodiment will be described with reference to FIG. 1 to FIG. 5. First, a schematic configuration of an image forming apparatus according to the first embodiment will be described with reference to FIG. 1.

[Image Forming Apparatus]

An image forming apparatus 100 is an electrophotographic full-color printer including four image forming portions 109Y, 109M, 109C, and 109Bk provided correspondingly to four colors of yellow, magenta, cyan, and black, respectively. In the first embodiment, there is employed a tandem type in which the image forming portions 109Y, 109M, 109C, and 109Bk are arranged along a rotation direction of an intermediate transfer belt 101 described later. The image forming apparatus 100 is configured to form a toner image (image) on a recording material P in accordance with an image signal from an original reading apparatus (not shown) connected to a main body of the image forming apparatus or from a host apparatus such as a personal computer connected to the main body of the image forming apparatus so as to be capable of performing data communication therewith. As the recording material, there may be given sheet materials such as paper, a plastic film, and a cloth.

The outline of such image forming process will be described. First, in the image forming portions 109Y, 109M, 109C, and 109Bk, toner images of the respective colors are formed on the respective photosensitive drums 103. The toner images of the respective colors formed in this manner are transferred onto the intermediate transfer belt 101, and are subsequently transferred from the intermediate transfer belt 101 onto the recording material P. The recording material having the toner images transferred thereon is conveyed to a fixing device 112, and the toner images are fixed onto the recording material. The detailed description will be given below.

The four image forming portions 109Y, 109M, 109C, and 109Bk of the image forming apparatus 100 have substantially the same structure except that developer colors are different. Therefore, in the following, the image forming portion 109Bk will be described as a representative, and description of the configurations of the other image forming portions is omitted.

In the image forming portion 109Bk, there is arranged a cylindrical photosensitive member serving as an image bearing member, that is, the photosensitive drum 103. Around the photosensitive drum 103, there are arranged a charging apparatus 104, an exposure device 105, a developing device 106, a primary transfer roller 107, and a cleaning device 108. The photosensitive drum 103 has a photosensitive layer having a negative polarity as a charging polarity formed on a surface thereof, and rotates at a predetermined processing speed in a direction indicated by the arrow. The charging apparatus 104 charges the surface of the photosensitive drum 103 to have a negative polarity. The detailed configuration of the charging apparatus 104 will be described later.

The exposure device 105 scans, by using a rotating mirror, a laser beam subjected to ON-OFF keying in accordance with scanning line image data obtained by developing a black separated color image, and forms an electrostatic image onto the charged surface of the photosensitive drum 103.

The developing device 106 triboelectrically charges a two-component developer containing a non-magnetic toner having a negative polarity as a charging polarity and a magnetic carrier with an agitating member. The developer is conveyed by a conveying member, and is carried by a developing sleeve 106a. The developer carried by the developing sleeve 106a is regulated in thickness by a regulating blade, and then, is conveyed to an opposing portion, which is opposed to the photosensitive drum 103. The developing sleeve 106a is held at a predetermined distance from the photosensitive drum 103. An oscillating voltage generated by superposing an alternating-current voltage on a negative direct-current voltage having a negative polarity is applied to the developing sleeve. With this, of the developer carried and conveyed to the opposing portion by the developing sleeve 106a, toner charged to have a negative polarity is transferred onto the charged portion of the photosensitive drum 103 charged to have a relatively positive polarity. In this manner, the electrostatic image is subjected to reverse development with the toner.

The primary transfer roller 107 forms a primary transfer portion T1 for primarily transferring the toner image from the photosensitive drum 103 to the intermediate transfer belt 101 between the photosensitive drum 103 and the intermediate transfer belt 101. A positive direct-current voltage is applied to the primary transfer roller 107, to thereby primarily transfer the toner image carried by the photosensitive drum 103 onto the intermediate transfer belt 101f. The cleaning device 108 causes a cleaning blade thereof to be brought into abutment against the photosensitive drum 103 so as to be opposed to the photosensitive drum 103 in a rotation direction of the photosensitive drum 103, to thereby remove untransferred residual toner remaining on the photosensitive drum 103.

Further, the intermediate transfer belt 101 is arranged so as to be opposed to the photosensitive drum 103. The intermediate transfer belt 101 is tensioned by a plurality of tensioning rollers, and is circumferentially moved in a direction indicated by the arrow through drive of the secondary transfer inner roller 110 also serving as a drive roller. A secondary transfer outer roller 111 serving as a secondary transfer member is arranged at a position opposed to the secondary transfer inner roller 110 across the intermediate transfer belt 101. Specifically, the secondary transfer outer roller 111 is held in abutment against an outer surface of the intermediate transfer belt 101 in a transport direction of the toner image (rotation direction of the intermediate transfer belt 101) in a range from the image forming portion 109Bk to a transfer cleaning blade 102. A secondary transfer portion T2 for transferring the toner image on the intermediate transfer belt 101 onto the recording material P is formed between the secondary transfer outer roller 111 and the intermediate transfer belt 101. A positive direct-current voltage is applied to the secondary transfer outer roller 111, to thereby secondarily transfer a full-color toner image carried by the intermediate transfer belt 101 onto the recording material P.

The transfer cleaning blade 102 is arranged at a position opposed to the tension roller 115 tensioning the intermediate transfer belt 101 across the intermediate transfer belt 101, and is configured to remove untransferred residual toner and paper powder adhering to the intermediate transfer belt 101 while being held in abutment against the intermediate transfer belt 101. Further, the tension surface of the intermediate transfer belt 10, which is tensioned by the tension rollers 113 and 114, is opposed to the respective photosensitive drums 103 of the image forming portions 109Y to 109Bk.

An optical sensor 116 is arranged at a position opposed to the tension roller 114 arranged on a downstream side with respect to the image forming portion 109Bk located on a most downstream side in the rotation direction of the intermediate transfer belt 101 across the intermediate transfer belt 101. The optical sensor 116 is configured to detect, for example, an image density of a toner image on the intermediate transfer belt 101. For example, a toner image (patch image) for control is formed on the intermediate transfer belt 101, and the image density of the toner image is detected by the optical sensor 116, to thereby adjust the image density.

The fixing device 112 is arranged on a downstream side in a recording material conveying direction with respect to the secondary transfer portion T2. The fixing device 112 heats and pressurizes the recording material P with a fixing roller 112a and a pressure roller 112b so as to melt toner, to thereby fix the image onto the surface.

A process of forming an image by the image forming apparatus 100 having the above-mentioned configuration will be described. First, when an image forming operation is started, the surface of the photosensitive drum 103 being rotated is uniformly charged by the charging apparatus 104. Next, the photosensitive drum 103 is exposed with laser light corresponding to an image signal emitted from the exposure device 105, to thereby form an electrostatic image corresponding to the image signal onto the photosensitive drum 103. The electrostatic image on the photosensitive drum 103 is developed into a visible image with toner stored in the developing device 106.

The toner image formed on the photosensitive drum 103 is primarily transferred onto the intermediate transfer belt 101 at the primary transfer portion T1. Toner (untransferred residual toner) that remains on the surface of the photosensitive drum 103 after the primarily transfer is removed by the cleaning device 108.

Such operation is sequentially performed in the respective image forming portions of yellow, magenta, cyan, and black, and the four-color toner images are superposed on one another on the intermediate transfer belt 101. After that, in synchronization with a timing of forming the toner image, the recording material P received in a recording material receiving cassette (not shown) is conveyed to the secondary transfer portion T2. Then, the four-color toner images on the intermediate transfer belt 101 are secondarily transferred in a collective manner onto the recording material P. Toner that remains on the intermediate transfer belt 101 without being transferred at the secondary transfer portion T2 is removed by the transfer cleaning blade 102.

Next, the recording material P is conveyed to the fixing device 112. Then, the recording material P is heated and pressurized by the fixing device 112 so that the toners on the recording material P are molten and mixed to be fixed as a full-color image onto the recording material P. After that, the recording material P is delivered to an outside of the apparatus. With this, the series of the image forming process is completed. A single-color image of a desired color or a multi-color image of desired colors may be formed by using only the image forming portion of the desired color.

[Controller]

Next, a controller 200 configured to control the above-mentioned image forming apparatus 100 will be described with reference to FIG. 2. The controller 200 serving as an execution portion includes a central processing unit (CPU) 201, a read only memory (ROM) 202, and a random access memory (RAM) 203. The CPU 201 controls each portion of the image forming apparatus 100 while reading out a program corresponding to a control procedure stored in the ROM 202. Further, working data and input data are stored in the RAM 203, and the CPU 201 performs control based on the above-mentioned program or the like with reference to the data stored in the RAM.

An operator can execute an image forming job of executing image formation by operating an operating portion 204 or a personal computer (PC) 205 provided in the image forming apparatus 100. The controller 200 receives a signal from the operating portion 204 or the like and controls various devices of the image forming apparatus 100 to operate.

[Charging Apparatus]

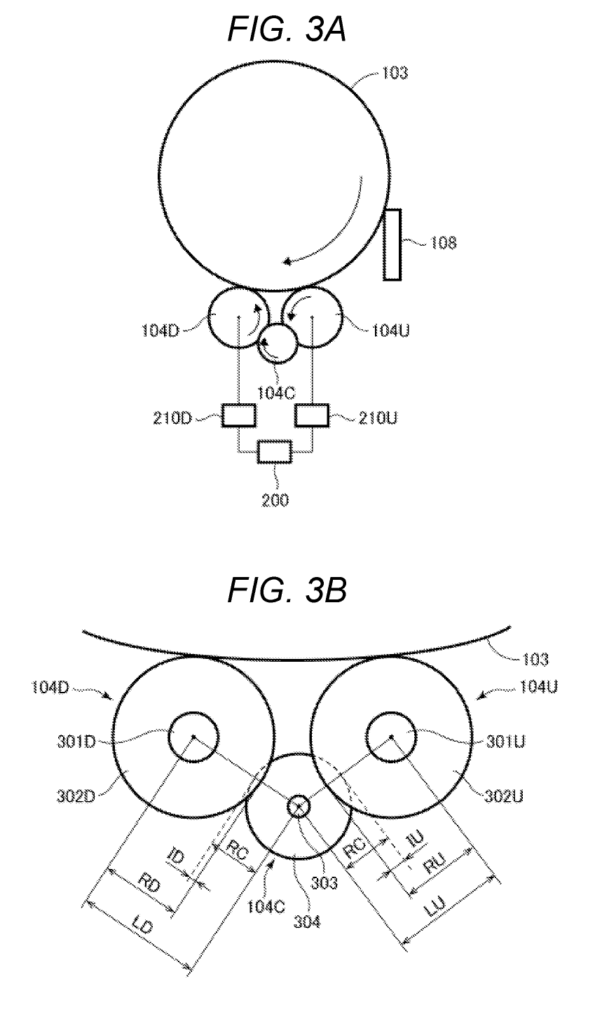

Next, the charging apparatus 104 according to the first embodiment will be described with reference to FIG. 3A to FIG. 5. As illustrated in FIG. 3A, the charging apparatus 104 includes a plurality of charging rollers. Specifically, the charging apparatus 104 includes an upstream charging roller 104U serving as a first charging member, a downstream charging roller 104D serving as a second charging member, and a single cleaning roller 104C serving as a cleaning member.

The upstream charging roller 104U is arranged on the downstream side with respect to the cleaning device 108 in the rotation direction of the photosensitive drum 103, and is configured to charge the surface of the photosensitive drum 103 by rotating in contact with the surface of the photosensitive drum 103. The downstream charging roller 104D is arranged on the downstream side with respect to the upstream charging roller 104U in the rotation direction of the photosensitive drum 103 so as to be adjacent to the upstream charging roller 104U, and is configured to charge the surface of the photosensitive drum 103 by rotating in contact with the surface of the photosensitive drum 103. The cleaning roller 104C is arranged between the upstream charging roller 104U and the downstream charging roller 104D, and is configured to rotate along with rotation of the upstream charging roller 104U and the downstream charging roller 104D in contact with surfaces of the upstream charging roller 104U and the downstream charging roller 104D. Further, the cleaning roller 104C is configured to clean the surfaces of the upstream charging roller 104U and the downstream charging roller 104D.

Only a direct-current voltage is applied to the upstream charging roller 104U from a power supply 210U so that the upstream charging roller 104U charges the surface of the photosensitive drum 103. A voltage obtained by superposing an alternating-current voltage on a direct-current voltage is applied to the downstream charging roller 104D from a power supply 210D so that the downstream charging roller 104D charges the surface of the photosensitive drum 103. The power supplies 210U and 210D are each controlled by the controller 200.

Further, as illustrated in FIG. 3B, the upstream charging roller 104U includes a metal core 301U, and a charging layer 302U provided around the metal core 301U. Similarly, the downstream charging roller 104D includes a metal core 301D, and a charging layer 302D provided around the metal core 301D. The metal cores 301U and 301D are each a shaft formed of a conductive member such as metal. The charging layers 302U and 302D are each formed of an elastic layer formed of conductive rubber provided around each of the metal cores 301U and 301D, and a surface layer covering a surface of the elastic layer.

The cleaning roller 104C includes a metal core 303, and a cleaning layer 304 provided around the metal core 303. The metal core 303 is a shaft formed of resin or metal. The cleaning layer 304 is obtained by forming porous foam such as sponge into a cylindrical shape. The detailed configuration of the cleaning roller 104C will be described later.

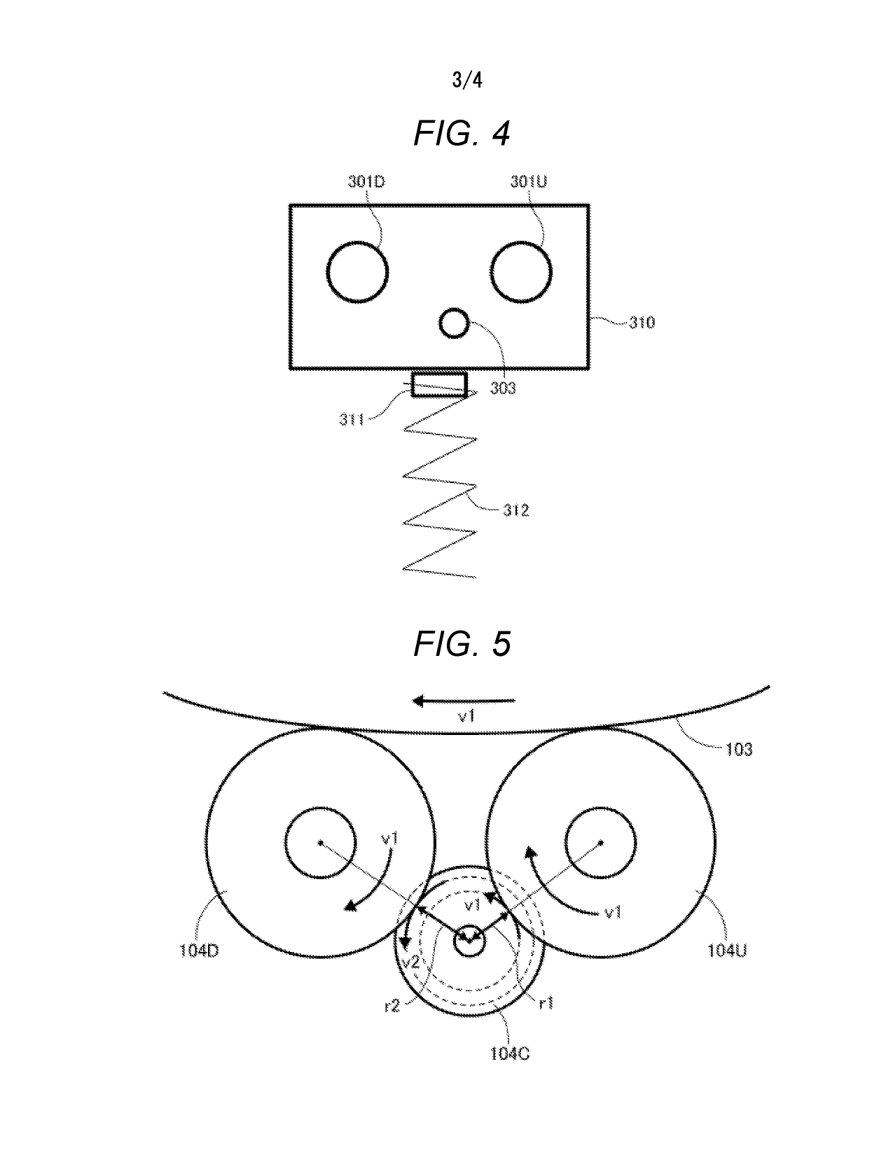

As illustrated in FIG. 4, the upstream charging roller 104U, the downstream charging roller 104D, and the cleaning roller 104C as described above are rotatably supported by bearings 310. The bearings 310 are arranged on both end sides in an axial direction of the upstream charging roller 104U, the downstream charging roller 104D, and the cleaning roller 104C, respectively, and rotatably support both the end portions of the respective metal cores 301U, 301D, and 303. With this, relative positions of the upstream charging roller 104U, the downstream charging roller 104D, and the cleaning roller 104C are determined, and, as described later, inroad amounts of the upstream charging roller 104U and the downstream charging roller 104D with respect to the cleaning roller 104C are defined.

Further, the bearings 310 are urged toward the photosensitive drum 103 side (upper side in FIG. 4) by a spring 312 serving as an urging unit through intermediation of a spring receiving portion 311. With this, the upstream charging roller 104U and the downstream charging roller 104D supported by the bearings 310 are urged toward the photosensitive drum 103, and each roller is held in abutment against the surface of the photosensitive drum 103.

[Cleaning Roller]

The cleaning roller 104C is formed using general foam sponge as a main component of the cleaning layer 304, and, as in FIG. 3B, the cleaning roller 104C is pressed against each of the upstream charging roller 104U and the downstream charging roller 104D so as to enter each of the upstream charging roller 104U and the downstream charging roller 104D. The cleaning roller 104C in the first embodiment is formed so as to have an outside diameter of 6 mm, and a length in a longitudinal direction (axial direction) of 230 mm.

Such cleaning roller 104C is obtained by spirally winding a sheet of foam sponge having a thickness of about 1.5 mm around the metal core 303 having an outside diameter of 2 mm, and adhering the sheet. In order to have a uniform outside diameter of the cleaning roller 104C, it is preferred that the surface of the cleaning roller 104C be ground after the sheet of the foam sponge is wound. Further, as a manufacturing method for the cleaning roller 104C, formation using a die may be employed. That is, a sponge material is poured into the die, and is put in an oven to be foamed and hardened. In this manner, a required shape is manufactured.

In the first embodiment, as described above, the single cleaning roller 104C is held in contact with both the upstream charging roller 104U and the downstream charging roller 104D, and the upstream charging roller 104U and the downstream charging roller 104D are cleaned by the single cleaning roller 104C. With this, as compared to a case in which the upstream charging roller 104U and the downstream charging roller 104D are cleaned by different cleaning rollers, respectively, the configuration of the charging apparatus 104 is simplified, thereby being capable of reducing the size of the charging apparatus 104.

The upstream charging roller 104U and the downstream charging roller 104D differ in degree of cleanliness at the time of image formation. That is, toner or an external additive adhering to the photosensitive drum 103 having passed through the cleaning device 108 are first brought into contact with the upstream charging roller 104U after the photosensitive drum 103 passes through the cleaning device 108, and hence often adheres to the upstream charging roller 104U. Further, in the case of the first embodiment, a charging type of the upstream charging roller 104U is direct-current charging, and hence dirt tends to lead to charging unevenness. For those reasons, a lifetime of the charging apparatus 104 is greatly influenced by dirt on the upstream charging roller 104. Therefore, it is desired to enhance cleaning performance for the upstream charging roller 104U. Thus, in the first embodiment, as described below, the inroad amounts of the upstream charging roller 104U and the downstream charging roller 104D with respect to the cleaning roller 104C are regulated.

[Inroad Amount with Respect to Cleaning Roller]

Next, the inroad amounts of the upstream charging roller 104U and the downstream charging roller 104D with respect to the cleaning roller 104C are described. As illustrated in FIG. 3B, an inroad amount IU of the upstream charging roller 104U with respect to the cleaning roller 104C is set larger than an inroad amount ID of the downstream charging roller 104D with respect to the cleaning roller 104C. In the first embodiment, as illustrated in FIG. 4 referred to above, positions at which the rollers are supported are regulated by the bearings 310 so as to achieve such relationship of the inroad amounts.

Further, the inroad amounts IU and ID are defined as follows. First, there are given a radius of the upstream charging roller 104U represented by RU, a radius of the cleaning roller 104C represented by RC, and a distance between center axes of the upstream charging roller 104U and the cleaning roller 104C represented by LU. In this case, IU derived from LU=RU+RC−IU, that is, IU=RU+RC−LU corresponds to the inroad amount IU of the upstream charging roller 104U with respect to the cleaning roller 104C. Similarly, there are given a radius of the downstream charging roller 104D represented by RD, and a distance between center axes of the downstream charging roller 104D and the cleaning roller 104C represented by LD. In this case, ID derived from LD=RD+RC−ID, that is, ID=RD+RC−LD corresponds to the inroad amount ID of the downstream charging roller 104D with respect to the cleaning roller 104C. The relative positions of the upstream charging roller 104U, the downstream charging roller 104D, and the cleaning roller 104C are regulated so as to satisfy IU>ID.

The inroad amount IU is set larger than the inroad amount ID as described above. Thus, a frictional force between the upstream charging roller 104U and the cleaning roller 104C is larger than a frictional force between the downstream charging roller 104D and the cleaning roller 104C. With this, the cleaning roller 104C rotates along with rotation of the upstream charging roller 104U dominantly. As a result, the cleaning performance for the upstream charging roller 104U by the cleaning roller 104C is enhanced.

As described above, in the case of the first embodiment, the inroad amount IU of the upstream charging roller 104U with respect to the cleaning roller 104C is set larger than the inroad amount ID of the downstream charging roller 104D with respect to the cleaning roller 104C. Therefore, with the configuration of cleaning the upstream charging roller 104U and the downstream charging roller 104D with the single cleaning roller 104C, dirt on the upstream charging roller 104 that greatly influences the lifetime of the charging apparatus 104 can be reduced, thereby being capable of providing the charging apparatus 104 with a long lifetime.

[Difference in Circumferential Speed Between Downstream Charging Roller and Cleaning Roller]

As described above, in the charging apparatus 104 according to the first embodiment, the cleaning roller 104C rotates along with rotation of the upstream charging roller 104U. In contrast, the cleaning roller 104C rotates with a difference in circumferential speed relative to the downstream charging roller 104D.

As illustrated in FIG. 5, the upstream charging roller 104U and the downstream charging roller 104D rotate along with rotation of the photosensitive drum 103. Therefore, the circumferential speed of each of the upstream charging roller 104U and the downstream charging roller 104D is v1, which is substantially equal to the circumferential speed of the photosensitive drum 103. Further, the cleaning roller 104C rotates along with rotation of the upstream charging roller 104U. At this time, the circumferential speed of the cleaning roller 104C at a position of being held in contact with the upstream charging roller 104U (radius r1) is v1.

Meanwhile, although the cleaning roller 104C is held in contact also with the downstream charging roller 104D, the inroad amount of the downstream charging roller 104D with respect to the cleaning roller 104C is smaller than the inroad amount of the upstream charging roller 104U with respect to the cleaning roller 104C. Therefore, the circumferential speed of the cleaning roller 104C at a position of being held in contact with the downstream charging roller 104D (radius r2>r1) is v2, which is higher than v1. As described above, the downstream charging roller 104D rotates at the circumferential speed v1, and hence the cleaning roller 104C rotates with the difference in circumferential speed relative to the downstream charging roller 104D.

In this case, v2=(r2/r1)×v1 is satisfied. In the first embodiment, the outside diameter of the cleaning roller 104C is 6 mm. The inroad amount IU of the upstream charging roller 104U is 0.5 mm. The inroad amount of the downstream charging roller 104D is 0.2 mm. In this case, r1 is 2.5 mm, and r2 is 2.8 mm. Thus, v2=1.12×v1 is satisfied. Therefore, in the case of the first embodiment, the cleaning roller 104C rotates with a difference in circumferential speed of +12% relative to the downstream charging roller 104D.

The cleaning roller 104C rotates with the difference in circumferential speed relative to the downstream charging roller 104D as described above. Thus, toner or an external additive adhering to the cleaning roller 104C can be blown off. As a result, the surface of the cleaning roller 104C is refreshed, thereby being capable of maintaining high cleaning performance for a long period of time.

### Second Embodiment

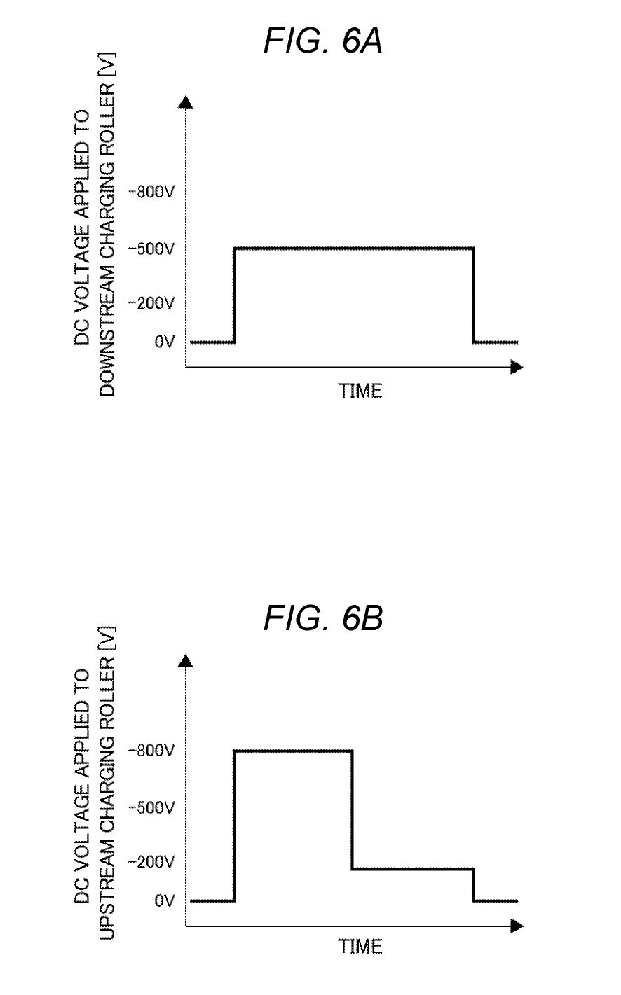

A second embodiment will be described with reference to FIG. 6A and FIG. 6B as well as FIG. 1, FIG. 3A, and FIG. 3B. In a case of the second embodiment, a discharge mode of discharging toner or an external additive adhering to the downstream charging roller 104D can be executed. Other configurations and actions are similar to those of the above-mentioned first embodiment. Thus, the same configurations are denoted by the same reference symbols, and differences from the first embodiment are mainly described below.

Also in the case of the second embodiment, similarly to the first embodiment, the inroad amount IU of the upstream charging roller 104U with respect to the cleaning roller 104C is set larger than the inroad amount ID of the downstream charging roller 104D with respect to the cleaning roller 104C. Therefore, toner or an external additive accumulates on the downstream charging roller 104D having the smaller inroad amount ID with respect to the cleaning roller 104C. Thus, in the second embodiment, in order to clean the downstream charging roller 104D, the discharge mode of discharging toner or an external additive adhering to the downstream charging roller 104D to the photosensitive drum 103 can be executed with a potential difference between the downstream charging roller 104D and the photosensitive drum 103. The toner discharged to the photosensitive drum 103 or the like is collected by the developing device 106 arranged on the downstream side with respect to the downstream charging roller 104D in the rotation direction of the photosensitive drum 103 or the cleaning device 108 serving as the photosensitive drum cleaning member.

When such discharge mode is executed for the upstream charging roller 104U, the toner discharged to the photosensitive drum 103 from the upstream charging roller 104U or the like may cause the downstream charging roller 104D to be unclean. Therefore, in the second embodiment, the discharge mode is executed only for the downstream charging roller 104D. Now, the discharge mode is specifically described.

[Discharge Mode]

The discharge mode is executed by controlling a voltage applied to the upstream charging roller 104U. That is, the controller 200 serving as the execution portion controls the power supply 210U configured to apply a voltage to the upstream charging roller 104U and the power supply 210D configured to apply a voltage to the downstream charging roller 104D. In this manner, the controller 200 can execute the discharge mode. In the discharge mode, the controller 200 controls the power supply 210U to apply a first direct-current voltage to the upstream charging roller 104U so that the surface of the photosensitive drum 103 is charged, and controls the power supply 210D to apply a second direct-current voltage, which is different form the first direct-current voltage, to the downstream charging roller 104D.

In the second embodiment, at the time of execution of the discharge mode, the second direct-current voltage applied to the downstream charging roller 104D is set to be constant, and, as the first direct-current voltage, a voltage higher than the second direct-current voltage and a voltage lower than the second direct-current voltage are each applied to the upstream charging roller 104U. That is, as the first direct-current voltage, the voltage higher than the second direct-current voltage and the voltage lower than the second direct-current voltage are each applied, and thus, toners having different polarities are each discharged from the downstream charging roller 104D.

More specific description is given with reference to FIG. 6A and FIG. 6B. At the time of normal image formation, a direct-current voltage of −500 V is applied to each of the upstream charging roller 104U and the downstream charging roller 104D, and, further, a voltage obtained by superposing the alternating-current voltage is applied to the downstream charging roller 104D.

In the discharge mode, as illustrated in FIG. 6A, a voltage of −500V, which is equal to that given at the time of image formation, is applied to the downstream charging roller 104D as the second direct-current voltage. In contrast, as illustrated in FIG. 6B, a voltage of −800V, which has an absolute value higher than that given at the time of image formation, is applied to the upstream charging roller 104U as the first direct-current voltage, and, after a predetermined period of time is elapsed, the absolute value of the first direct-current voltage is reduced to have a voltage of −200V. That is, the voltage of −800V is applied to the upstream charging roller 104U for a first predetermined period of time in the discharge mode, and the voltage of −200V is applied to the upstream charging roller 104U after the predetermined period of time is elapsed.

The direct-current voltage of −800V is applied to the upstream charging roller 104U for the first predetermined period of time in the discharge mode as described above. Thus, an absolute value of a surface potential of the photosensitive drum 103, which is charged by the upstream charging roller 104U, is increased from that given at the time of image formation. Therefore, the direct-current voltage of −500V, which is equal to that given at the time of image formation, is applied to the downstream charging roller 104D. Thus, toner or an external additive (being a positive component) adhering to the downstream charging roller 104D, which is positively charged, is discharged to the photosensitive drum 103 due to a potential difference.

Further, after the predetermined period of time is elapsed, the direct-current voltage of −200V is applied to the upstream charging roller 104U. Thus, the absolute value of the surface potential of the photosensitive drum 103, which is charged by the upstream charging roller 104U, is reduced from that given at the time of image formation. Therefore, a direct-current voltage of −500V, which is equal to that given at the time of image formation, is applied to the downstream charging roller 104D. Thus, toner or an external additive (being a negative component) adhering to the downstream charging roller 104D, which is negatively charged, is discharged to the photosensitive drum 103 due to a potential difference.

In the second embodiment, such discharge mode is executed, for example, at at least one of a time of start of an image forming job or a time of completion of the image forming job, or is executed, after the image forming job is interrupted, at the time the number of sheets of the image formation reaches a predetermined number. The discharge mode may be executed, for example, at another timing, for example, at the time of activation of a power supply for the image forming apparatus as well as at at least one or a plurality of those timings.

In the case of the second embodiment, such discharge mode is executed. Thus, dirt on the downstream charging roller 104D having a smaller inroad amount with respect to the cleaning roller 104C can be suppressed. As a result, through rotation of the cleaning roller 104C along with rotation of the upstream charging roller 104U, the upstream charging roller 104U is sufficiently cleaned. Even when the cleaning for the downstream charging roller 104D by the cleaning roller 104C is not sufficient, the downstream charging roller 104D is cleaned through execution of the discharge mode. Therefore, in the case of the second embodiment, the charging apparatus with a long lifetime, which is less liable to cause an image failure, can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-183031, filed Sep. 22, 2017, which is hereby incorporated by reference herein in its entirety.

What is claimed is:

1. A charging apparatus comprising:
a first charging roller configured to charge a surface of a photosensitive drum by rotating in contact with the surface of the photosensitive drum;
a second charging roller configured to charge the surface of the photosensitive drum by rotating in contact with the surface of the photosensitive drum at a position adjacent to and downstream of a position at which the first charging roller is in contact with the surface of the photosensitive drum with respect to a rotation direction of the photosensitive drum; and
a cleaning roller configured to clean a surface of the first charging roller and a surface of the second charging roller by rotating along with rotation of the first charging roller and the second charging roller in contact with the surface of the first charging roller and the surface of the second charging roller, an inroad amount of the first charging roller into the cleaning roller being larger than an inroad amount of the second charging roller into the cleaning roller.

2. A charging apparatus according to claim 1, wherein an outside diameter of the first charging roller is substantially equal to an outside diameter of the second charging roller,
wherein a circumferential speed of the cleaning roller is substantially equal to a circumferential speed of the first charging roller at a contact portion between the cleaning roller and the first charging roller, and
wherein the circumferential speed of the cleaning roller is higher than a circumferential speed of the second charging roller at a contact portion between the cleaning roller and the second charging roller.

3. A charging apparatus according to claim 1, wherein only a direct-current voltage is applied to the first charging roller so that the first charging roller charges the surface of the photosensitive drum.

4. A charging apparatus according to claim 1, wherein a voltage obtained by superposing an alternating-current voltage to a direct-current voltage is applied to the second charging roller so that the second charging roller charges the surface of the photosensitive drum.

5. An image forming apparatus comprising:
a photosensitive drum;
a first charging roller configured to charge a surface of the photosensitive drum by rotating in contact with the surface of the photosensitive drum;
a second charging roller configured to charge the surface of the photosensitive drum by rotating in contact with the surface of the photosensitive drum at a position adjacent to and downstream of a position at which the first charging roller is in contact with the surface of the photosensitive drum with respect to a rotation direction of the photosensitive drum;
a cleaning roller configured to clean a surface of the first charging roller and a surface of the second charging roller by rotating along with rotation of the first charging roller and the second charging roller in contact with the surface of the first charging roller and the surface of the second charging roller, an inroad amount of the first charging roller into the cleaning roller being larger than an inroad amount of the second charging roller into the cleaning roller;
an image forming portion configured to form an image on a recording material by forming a toner image on the charged photosensitive drum and transferring the toner image onto the recording material; and
an execution portion configured to execute a mode of applying a first direct-current voltage to the first charging roller so that the first charging roller charges the surface of the photosensitive drum and applying a second direct-current voltage, which is different from the first direct-current voltage, to the second charging roller.

6. An image forming apparatus according to claim 5, wherein the execution portion sets the second direct-current voltage to be constant at a time of executing the mode, and applies a voltage higher than the second direct-current voltage and a voltage lower than the second direct-current voltage as the first direct-current voltage.

7. An image forming apparatus according to claim 5, further comprising a photosensitive drum cleaning member configured to clean the surface of the photosensitive drum at a position downstream of the position at which the second charging roller is in contact with the surface of the photosensitive drum and upstream of the position at which the first charging roller is in contact with the surface of the photosensitive drum with respect to the rotation direction of the photosensitive drum.
